(19) United States
(12) Patent Application Publication
(10) Pub. No.: US 2017/0166282 A1
(43) Pub. Date: Jun. 15, 2017

(54) CRANK ASSEMBLY OF A SHAFT DRIVEN BICYCLE

(71) Applicant: Jen-Chih Liu, Kaohsiung City (TW)

(72) Inventor: Jen-Chih Liu, Kaohsiung City (TW)

(21) Appl. No.: 14/968,922

(22) Filed: Dec. 15, 2015

(51) Int. Cl. B62M 11/02; B62M 17/00; B62M 3/00; B62M 1/36

(52) U.S. Cl. CPC B62M 11/02; B62M 1/36; B62M 17/00; B62M 3/00

(57) ABSTRACT

A crank assembly of a shaft driven bicycle includes a crank arm pivoted to an axis of a bicycle frame for arranging pedal. The crank arm has at least one main transmission gear to be engaged with a passive gear of a passive shaft. Teeth of the main transmission gear face opposite to the crank arm. The main transmission gear of the crank assembly won't interfere with the axis of the bicycle, and the main transmission gear is driven directly by the crank arms for better power transmission efficiency.

The present invention is a continuation in part (CIP) of U.S. Ser. No. 14/042,745, which has the inventor of and assigned to the applicant of the present invention, and therefore, the contents of U.S. Ser. No. 14/042,745 is incorporated into the present invention as a part of the present invention.

### FIELD OF THE INVENTION

The present invention relates to crank of a shaft driven bicycle, and particular to a crank assembly having a main transmission gear to be engaged by a passive gear of a passive shaft. The main transmission gear has teeth facing opposite to the crank.

### DESCRIPTION OF THE PRIOR ART

Prior transmission mechanism of a bicycle is done by chain connecting to two gears for transmitting power. However chains could cause inconvenient and dangerous situations such as being jammed by cyclist's pants, or fall due to the jam of chain.

Therefore, a shaft driven bicycle is presented to get rid of the chain mechanism. The chain driven mechanism and the shaft driven mechanism is not compatible to each other, both mechanisms need its own frame design to support the mechanism. Known shaft driven mechanisms are designed using a main transmission gear fixed to the axis of the bicycle frame, and the main transmission gear is driven by crank arms pivoted to the axis so that the main transmission gear is rotated with the axis. For the main transmission gear is arranged to the axis of frame, the arrangement of transmission mechanism and overall balance is limited. Moreover, the manufacture cost and assembly for such main transmission gear is higher and complex so that an improvement for the practicability and economic benefit of the product is urgently needed.

### SUMMARY OF THE PRESENT INVENTION

Accordingly, the primary object of the present invention is to provide a crank assembly for a shaft driven bicycle to avoid a limitation of space or designed balance of the bicycle and to efficiently lower the manufacture and assembly cost of the main transmission gear. The main transmission gear driven directly by the crank also provides higher power transmission efficiency so as to improve the practicability and economic benefit of the product.

To achieve above object, the present invention provides a crank arm (2) having an axis sleeve (21) at one end thereof; a shaft (1) passing through an inner hollow portion of the axis sleeve (21); the crank arm (2) having a joint (22) extending from an outer lateral side of the axis sleeve (21); at least one main transmission gear (3) fixed to a distal end of the joint (22) of the crank arm (2) far away from the axis sleeve (21) so that the joint (22) links between the main transmission gear (3) and the axis sleeve (21); a teeth portion (31) of the main transmission gear (3) of the crank arm 2 face opposite to the crank arm (2); a passive transmission shaft (5) having a passive gear (51) arranged around a shaft portion of the passive transmission shaft (5); the passive gear (51) of the passive transmission shaft (5) being engaged to the teeth portion (31) of the main transmission gear (3) and being at an opposite side of the crank arm (2) so as to transmit rotation operation of the passive gear (51) of the passive shaft (5) to the main transmission gear (3); a sheath (6) having a central through hole (61); the axial sleeve (21) of the crank arm (2) passing through the central through hole (61) of the sheath (6); by this structure, the sheath (6) being engaged to the axial sleeve (21) of the crank arm by using a bearing (62); the sheath (6) having a lateral recess (63) which receives the passive shaft (5); and passive gear (51) being arranged to the crank arm (2) through a central through hole thereof; a predetermined portion outside the lateral recess (63) of the sheath (6) being fixed to a frame of a bicycle.

The main transmission gear transits rotation operation of the crank arm to the passive shaft.

### BRIEF DESCRIPTION OF THE DRAWINGS

FIG. 1 is a cross-section view showing the first embodiment of a main transmission gear of the present invention.

FIG. 2 is a cross-section view showing the second embodiment of the main transmission gear of the present invention.

FIG. 3 is a cross-section view showing the assembly of the first embodiment of present invention.

FIG. 4 is a cross-section view showing the assembly of the second embodiment of present invention

FIG. 5 is a cross-section view showing the assembly of the present invention to a main frame of a bicycle.

FIG. 6 is an enlarged view showing a crank assembly in FIG. 5.

FIG. 7 is a cross-section view showing an embodiment of a sheath of the present invention.

FIG. 8 is a cross-section view showing another embodiment of the sheath of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

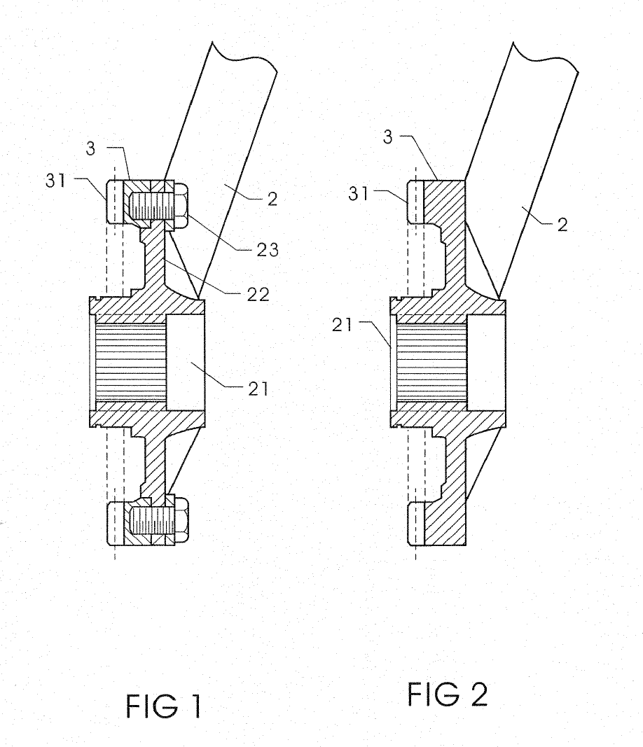

Referring to FIGS. 1 and 2, preferable embodiments of the present invention mainly have the following elements.

Referring to FIG. 1, the crank arm 2 has an axis sleeve 21 at one end thereof. A shaft 1 passes through an inner hollow portion of the axis sleeve 21. The crank arm 2 has a joint 22 extends from an outer lateral side of the axis sleeve 21.

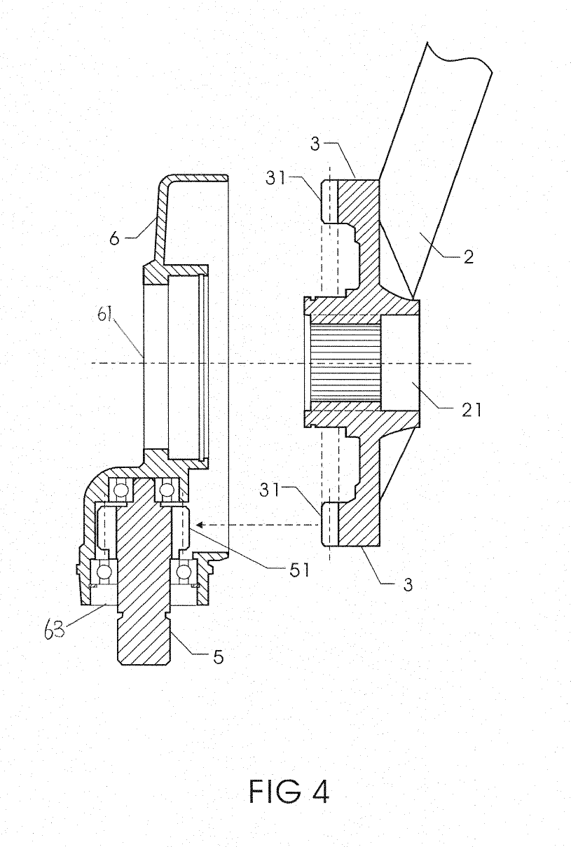

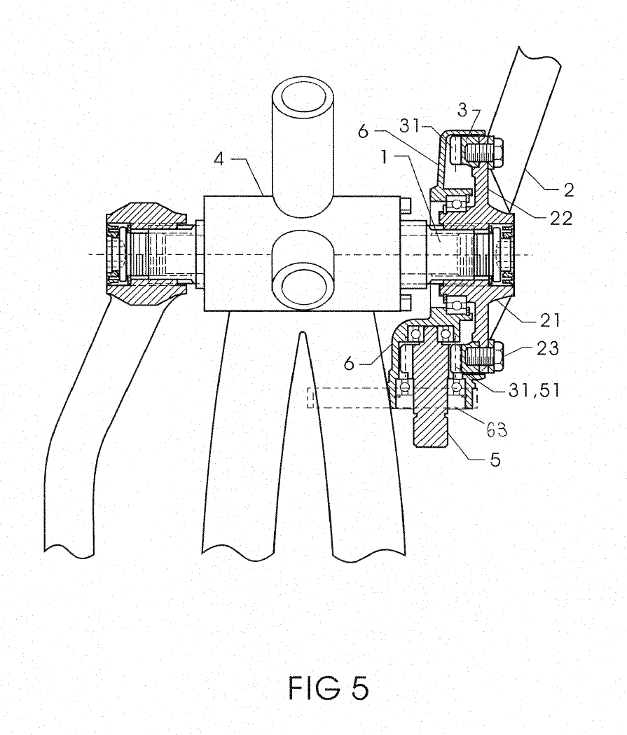

With reference to FIGS. 4 and 5, at least one main transmission gear 3 is fixed to a distal end of the joint 22 of the crank arm 2 far away from the axis sleeve 21 so that the joint 22 links between the main transmission gear 3 and the axis sleeve 21. A fixing component 23 serves to pass through a penetrating hole at the distal end of the joint 22 and an inner side of a ring of the main transmission gear 3 so as to retain the main transmission gear 3 to the joint 22. In this embodiment, two main transmission gears 3 are illustrated.

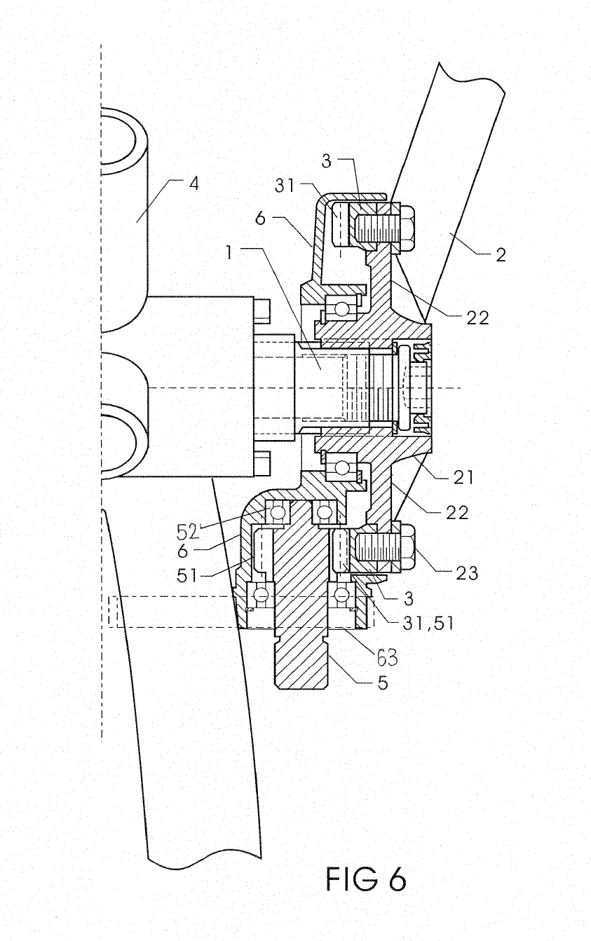

The main transmission gear 3 is one of a face gear, bevel gear, screw gear, hypoid gear, or other type of gear. In the present embodiment, the main transmission gear 3 is a face gear as shown in FIGS. 6 to 8. A teeth portion 31 of the main transmission gear 3 of the crank arm 2 (or axis sleeve 21) face opposite to the crank arm 2.

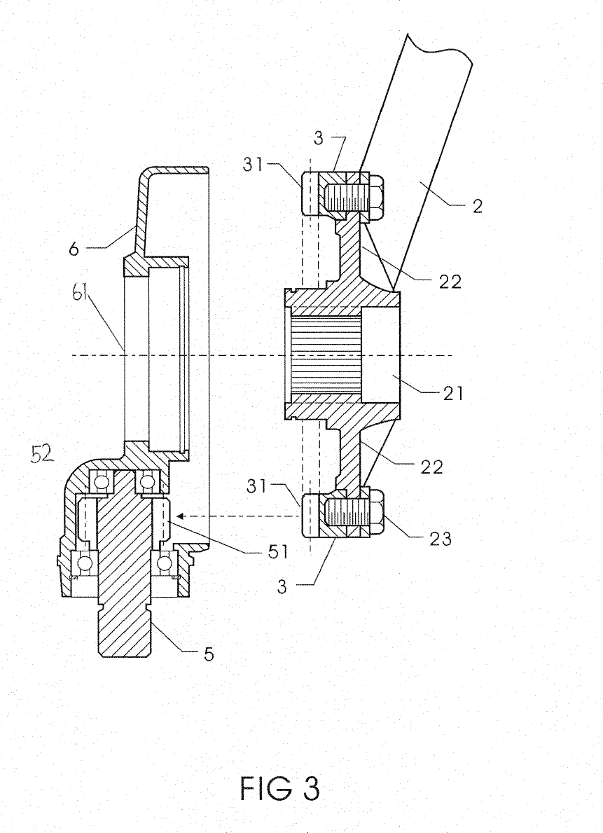

A passive transmission shaft 5 has a passive gear 51 arranged around a shaft portion of the passive transmission 5. The passive gear 51 of the passive transmission shaft 5 is engaged to the teeth portion 31 of the main transmission gear 3 and is at an opposite side of the crank arm 2 so as to transmit rotation operation of the passive gear 51 of the passive shaft 5 to the main transmission gear 3 as illustrated in FIGS. 3, 5, and 6.

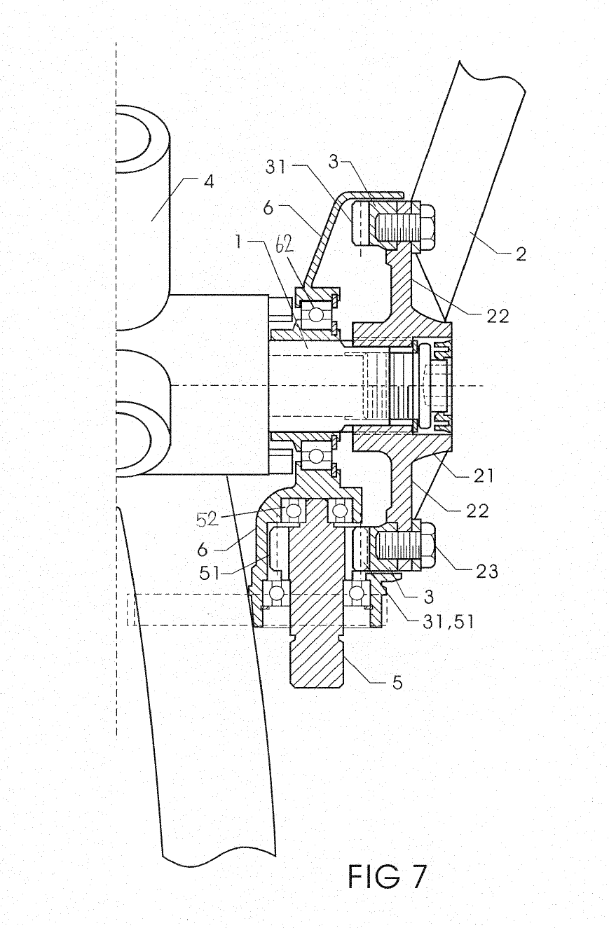

Referring to FIGS. 5, 6 and 7, a sheath 6 has a central through hole 61. The axial sleeve 21 of the crank arm 2 passes through the central through hole 61 of the sheath 6. By this structure, the sheath 6 is engaged to the axial sleeve 21 of the crank arm by using a bearing 62. The sheath 6 has a lateral recess 63 which receives the passive shaft 5 and passive gear 51 is arranged to the crank arm 2 through a central through hole thereof with a bearing 52 arranged therebetween. A predetermined portion outside the lateral recess 63 of the sheath 6 is fixed to the frame 4 of the bicycle as shown in FIG. 7.

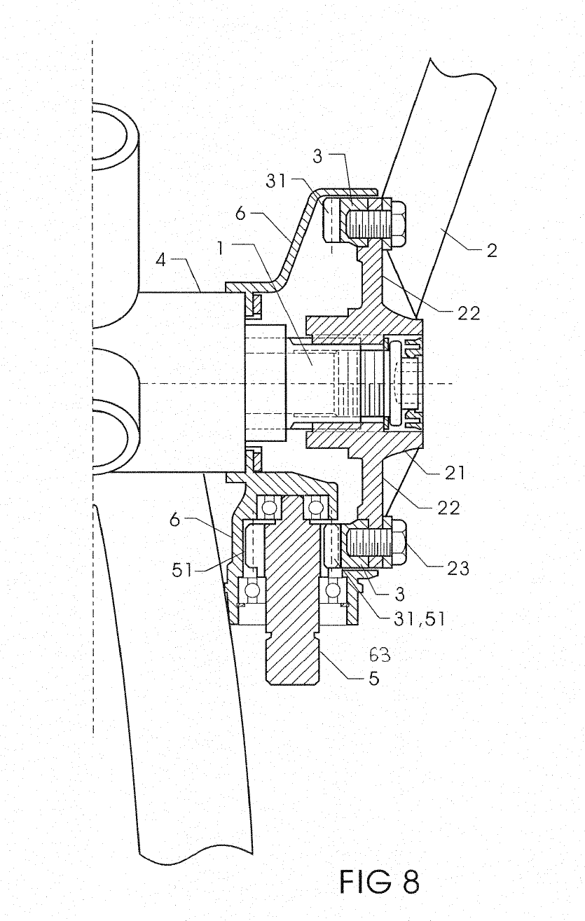

Referring to FIG. 8, the central through hole of the sheath 6 can also be fixed to the frame 4 as needed.

Referring to FIG. 2, another embodiment of the present invention is illustrated. This embodiment is similar to above mentioned embodiment illustrated in FIGS. 1, and 3 to 6. Therefore, those identified by the same numerals have the same structures and functions and thus the details of these elements are not described in details herein. At this embodiment, the at least one ring of main transmission gear 3 are integrally formed with the crank arm 2 or an axis sleeve 21 of the crank arm 2. Teeth 31 of the main transmission gear 3 face opposite to the crank arm 2 so as to transmit cycle to passive gear 51 of the passive shaft 5 engaged to the main transmission gear 3 under the sheath 6 as shown in FIG. 4.

Through the above components, the present invention has the following improvements.

1. The assembly of the main transmission gear of a shaft driven bicycle is improved to avoid a limitation of space or designed balance of the bicycle so as to increase practicality of the product.

2. To efficiently lower the manufacture and assembly cost of the main transmission gear so as to increase benefit of the product.

3. The main transmission gear of a shaft driven bicycle can be driven directly by the crank arms for better efficiency and the assembly won't interfere with the axis of the frame of the bicycle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A crank assembly of a shaft driven bicycle comprising:
a crank arm (2) having an axis sleeve (21) at one end thereof; a shaft (1) passing through an inner hollow portion of the axis sleeve (21); the crank arm (2) having a joint (22) extending from an outer lateral side of the axis sleeve (21);
at least one main transmission gear (3) fixed to a distal end of the joint (22) of the crank arm (2) far away from the axis sleeve (21) so that the joint (22) links between the main transmission gear (3) and the axis sleeve (21); a teeth portion (31) of the main transmission gear (3) of the crank arm 2 face opposite to the crank arm (2);
a passive transmission shaft (5) having a passive gear (51) arranged around a shaft portion of the passive transmission shaft (5); the passive gear (51) of the passive transmission shaft (5) being engaged to the teeth portion (31) of the main transmission gear (3) and being at an opposite side of the crank arm (2) so as to transmit rotation operation of the passive gear (51) of the passive shaft (5) to the main transmission gear (3);
a sheath (6) having a central through hole (61); the axial sleeve (21) of the crank arm (2) passing through the central through hole (61) of the sheath (6); by this structure, the sheath (6) being engaged to the axial sleeve (21) of the crank arm by using a bearing (62); the sheath (6) having a lateral recess (63) which receives the passive shaft (5); and passive gear (51) being arranged to the crank arm (2) through a central through hole thereof; a predetermined portion outside the lateral recess (63) of the sheath (6) being fixed to a frame of a bicycle;
wherein the main transmission gear transits rotation operation of the crank arm to the passive shaft.

2. The crank assembly of a shaft driven bicycle as claimed in claim 1, wherein a fixing component (23) passes through a penetrating hole at a distal end of the joint (22) and an inner side of a ring of the main transmission gear (3) so as to retain the main transmission gear (3) to the joint (22).

3. The crank assembly of a shaft driven bicycle as claimed in claim 1, wherein the at least one main transmission gear is integrally formed with the crank arm, and the teeth of the main transmission gear face opposite to the crank arm.

4. The crank assembly of a shaft driven bicycle as claimed in claim 1, wherein the main transmission gear is one of a face gear, bevel gear, screw gear, hypoid gear, and other types of gear.
